(19) United States
(12) Patent Application Publication
(10) Pub. No.: US 2014/0214369 A1
(43) Pub. Date: Jul. 31, 2014

(54) METHOD FOR PROVIDING PARAMETRIC DATA FOR CAD SOFTWARE

(71) Applicant: Jim Watson, Mooresville, NC (US)

(72) Inventor: Jim Watson, Mooresville, NC (US)

(21) Appl. No.: 14/068,492

(22) Filed: Oct. 31, 2013

Related U.S. Application Data
(60) Provisional application No. 61/720,965, filed on Oct. 31, 2012.

(51) Int. Cl. G06F 17/50

(52) U.S. Cl. CPC G06F 17/50
USPC 703/1

(57) ABSTRACT

CAD data is provided by the steps of providing raw 2D data points of a given shape, fitting said data points with geometry using regression analysis; applying lines and arcs to the data with parametric statistics; editing the parametric data inside CAD software.

### FIELD OF THE INVENTION

The present invention relates to a method and system for improving computer aided design (CAD) software. More specifically, the present invention relates to a method and system for providing parametric curves with constraints for 2D and 3D CAD software.

### BACKGROUND OF THE INVENTION

Computer aided design software is commonly used by engineers and other professionals to create or modify designs One technique is to use CAD software to create a design directly on a computer monitor by using computer drafting “tools” such as lines, arcs, splines and the like which @re provided on a tool bar in the display on the monitor. Another technique is to use a coordinate measuring apparatus to input data in the form of points defined by “X”, “V”, and “Z” coordinates, which points are then used to define lines and arcs of sections or surfaces to define a design.

in both of the above techniques, CAD software generally uses mathematical algorithms to create lines from a limited number of points input into the software to provide a so-called “geometry” based representation of the object of the design. Unfortunately, geometry based representations are not to scale, Le., they do not have dimensions and, hence, are not suitable without further processing for use in manufacture of parts or other objects. Also, geometry based representations provide curves and arcs with endpoints that are not tangent, i.e., a line which includes curves, arcs, splines and the like is represented by separate geometric line shapes with endpoints which do not exactly match up so that the line is not continuous. As a practical matter, geometry based representations work well for many purposes, but are problematic where one tries to scale up a drawing to make a part or where one has two drawings of different parts which are intended to fit closely together. In these situations, it would be desirable to have “parametric” based drawings.

In accordance with the present invention, a method and system is provided to overcome the above disadvantages of geometry based CAD software by provided the ability to do curve fitting from points collected from a spread sheet or input device. The present invention provides a parametric curve with constraints that can be modified or edited directly inside of modeling software. For example, the present invention enables a CAD user to readily modify an aircraft part, such as an airplane cowling, by scanning the part into a CAD database using a coordinate measuring apparatus and then designing changes to the shape of the part or modifications such as additions to the part using a CAD system. The changes/modifications can be represented in proper dimensions so that fitting is not an issue. Of course, the method and system of this invention enjoys wide application in the automotive and other

Further understanding of this invention will be had from the following specification and claims taken in conjunction with the accompanying drawings.

### BRIEF DESCRIPTION OF THE DRAWINGS

FIG. 1 shows the steps of a preferred embodiment of the present invention;

FIG. 2 shows a set of points provided by 3 coordinate measuring apparatus, which points are used to define a line;

FIG. 3 shows a line based on the points of FIG. 2, which line is provided by the method of FIG. 1; and

FIG. 4 shows a pair of lines, each of which lies in a plane as taken in section.

### SUMMARY OF THE INVENTION

CAD data is provided by the steps of providing raw 2D data points of a given shape, fitting said data points with geometry using regression analysis; applying lines and arcs to the data with parametric statistics; and then editing the parametric data inside CAD software.

### DESCRIPTION OF THE INVENTION

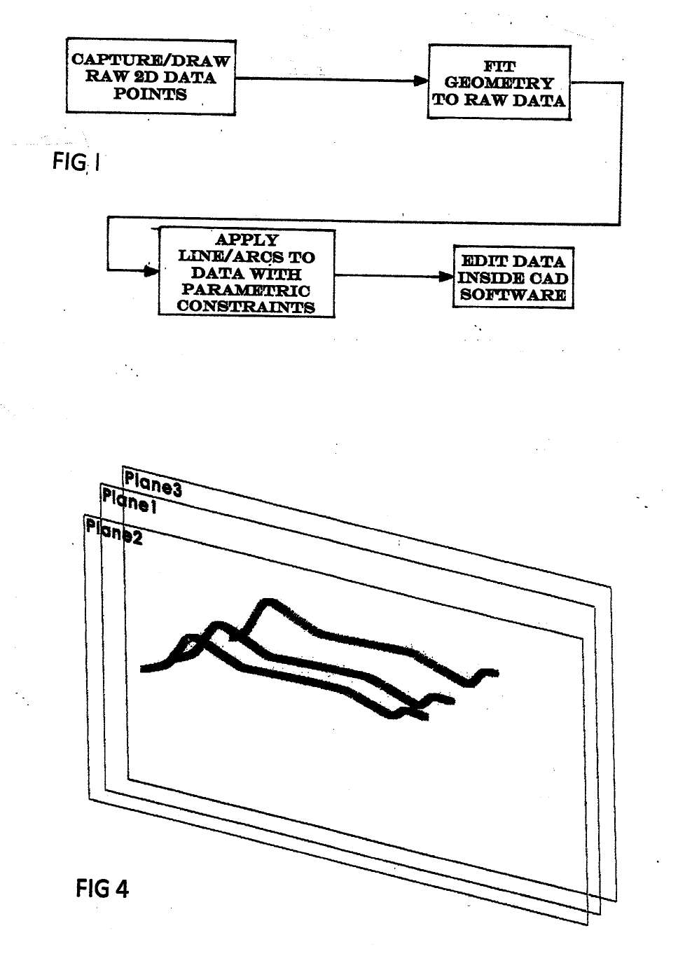

Now referring to FIG. 1, the steps of the present invention are shown in block diagram. Generally speaking, the steps involve first providing raw 2D data points of a shape, then interpolating and applying geometry to the data by regression analysis, then applying lines and arcs to the data with parmetric statistics; and finally, editing the data inside CAD software.

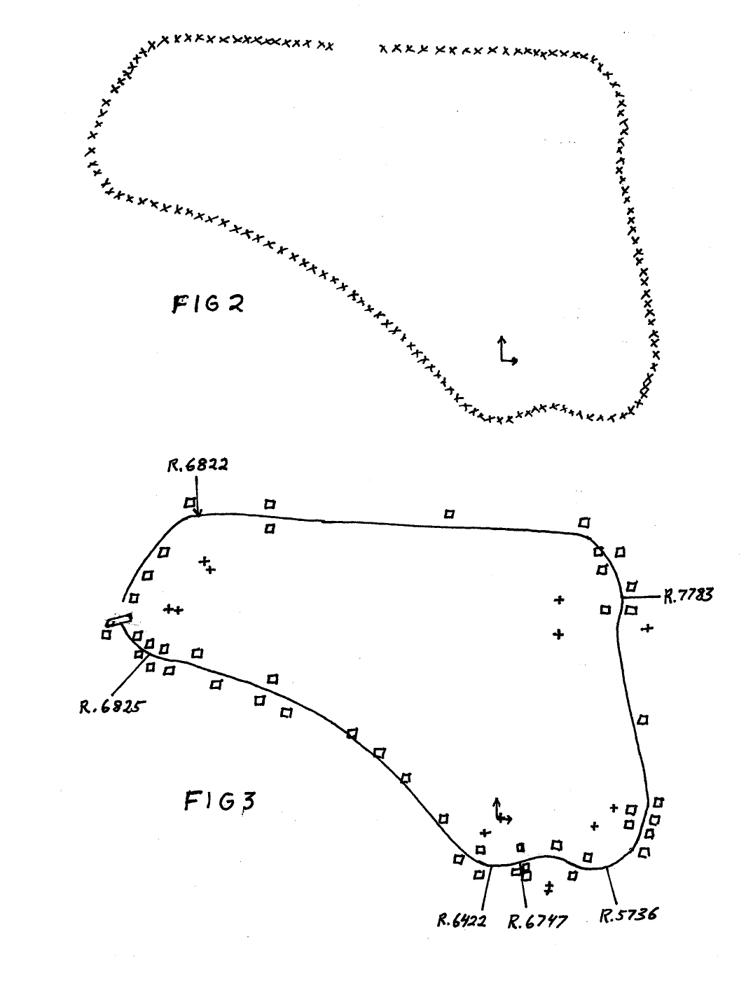

The step of providing raw 2D data points can be carried out by drawing shapes or splines using suitable CAD software or by capturing data using a coordinate measuring apparatus. Suitable drawing software is commercially available. Suitable coordinate measuring apparatus is also commercially available. Data points obtained from a coordinate measuring apparatus is illustrated in FIG. 2. It will be appreciated by those skilled in the art that the data points of FIG. 2 provide a geometry based representation of a line and are not dimensioned. It will also he appreciated by those skilled in the art that the end points of the various arcs and straight lines of the figure do not exactly come together, i.e., they are not tangent lines at their endpoints.

The step of interpolating the data points and applying geometry to the data is illustrated in FIGS. 2 and 3. As shown in FIG. 2, the data points obtained from a coordinate measuring apparatus are positioned with a degree of error so that they do not define the desired line without interpolation. Fortunately, the data points can be used to define a geometric line by using regression analysis. Unfortunately, such analysis and geometric representation does not provide lines and arcs which are accurate and dimensionable as desired. Thus, another step is required by the present invention.

To provide the desired parametric representation with constraints, the data is further processed by applying lines and arcs to the data with parametric statistics that allow for the geometry to be constrained and dimensionable. This step includes matching the endpoints of all lines and arcs to provide continuous lines and arcs, the results of which is illustrated in FIG. 3.

Finally, the parametric data of the previous step can now be edited by a user directly inside of CAD software. Suitable CAD software includes Solid Works.

It will be appreciated by those skilled in the art that the present invention provides a means by which separate parts can be accurately designed to fit together and that designs can be drawn and scaled up or down for manufacture by CAD manufacturing methods.

It will be further appreciated by those skilled in the art that the present invention may be subject to modification and variation within the broad scope of the invention which is intended to be limited only by the appended claims. What is claimed is:

1. The method of providing CAD data in parametric form with constraints by
(A) providing raw 2D data points of a shape;
(B) interpolating and applying geometry to the data by regression analysis;
(C) applying lines and arcs to the data with parmetric statistics; and
(D) editing the data inside CAD software.
